(19) United States
(12) Patent Application Publication
(10) Pub. No.: US 2009/0208630 A1
(43) Pub. Date: Aug. 20, 2009

(54) Spout pouch ice cream and frozen yogurt manufacturing method and device thereof

(76) Inventors: Young-Soo Koh, Torrence, CA (US); Yong-Dong Park, Gimhae-Si (KR)

Correspondence Address: THE NATH LAW GROUP, 112 South West Street, Alexandria, VA, 22314, US

(21) Appl. No.: 12/071,335

(22) Filed: Feb. 20, 2008

(51) Int. Cl. A23G 9/20; A23G 9/22; A23G 9/04

(52) U.S. Cl. 426/565; 62/233; 62/344

(57) ABSTRACT

The present invention relates to a spout pouch ice cream and frozen yogurt manufacturing method and a device capable of injecting ice cream after an overrun process through a narrow drinking tube of the spout pouch. In accordance with the present invention, the ice cream or the frozen yogurt can be injected into the inner diameter (8 to 9 mm) of the drinking tube of the spout pouch. Accordingly, it is possible to manufacture the spout pouch type of ice cream or frozen yogurt that can have the advantages of the spout pouch and enjoy the natural taste of ice cream or frozen yogurt.

### 1. FIELD OF THE INVENTION

The present invention relates to spout pouch ice cream and frozen yogurt manufacturing method and its device; specifically, a manufacturing process and method and its device capable of injecting ice cream, after an overrun process, through a narrow drinking tube of a spout pouch.

### 2. DESCRIPTION OF THE RELATED ART

Recently, manufactured ice cakes, beverages or milk shakes are injected into a spout pouch and sold to consumers similar to ice cream.

The spout pouch is held and squeezed by hand to consume. The spout pouch has advantages when compared to an existing cone type or bar type of ice cream products, the spout pouch products do not stick to a hand and can be consumed by desired amount and the leakage of the products can be prevented by the use of a closure.

The products using such a spout pouch are different from general ice cream.

Generally, the ice cream is produced utilizing a process called an overrun (to inject air into ice cream) during manufacturing of the ice cream to obtain softer texture.

U.S. Food & Drug Administration and the supervisory office of daily products have approved that the process capable of inflating the amount of products can be only applied to ice cream.

The overrun process uses a device called a freezer and all ice creams are manufactured by injecting raw materials of ice cream and air into a product container through a freezer under constant freezing temperature and pressure irrespective of their size. The working temperature of the overrun process is −30 to 50° F.

At this time, the amount of overrun (volume ratio relative to the raw materials of ice cream) is previously determined depending on the product grade.

The ice cream grade distributed in the U.S. is sorted as follows:

First grade (Super-premium): 25 to 40% overrun

Second grade (Premium): 40 to 80% overrun

Third grade (Regular): 80 to 100% overrun.

The ice cream manufactured by the process as described above is already frozen so that its viscosity is high. Therefore, it is difficult to fill the ice cream in an inner diameter (8 to 9 mm) of the drinking tube of the spout pouch.

Mixed milk shakes similar to the ice cream have been sold in Japan and Korea, wherein the mixed milk shakes are injected and frozen in the spout pouch container.

Both Japan and Korea can not use a product name of ice cream to the above product as there is also a difference in raw materials (in both Japan and Korea they use the raw materials manufactured with dried milk). Also both Japan and Korea have not developed a technology for injecting the frozen ice cream into the spout pouch container through the overrun process so that a crude liquid in a liquid state is injected and frozen into the spout pouch container.

Therefore, consumers recognize such a product as a combination of milk shake and smoothie since the moisture included in the raw materials in an ice state is frozen so that pieces of ice are included in contents. This is an alternative product manufactured due to the absence of the method of injecting the ice cream into the spout pouch as described above.

The spout pouch primarily comprises a pouch bag 10 and a drinking tube 20 fixed to an upper end of the pouch bag 10 as shown in FIG. 1.

The drinking tube 20 comprises a closure 30, a closure coupling part 22 coupled to the closure 30 and being a part that goes into a mouth upon drinking, a stopper 24 formed on a lower portion of the closure coupling part 22 to limit a coupling length of the closure 30, a fixing part 29 coupled to the pouch bag 10 on an opposite side of the closure coupling part 22, an engaging part 28 formed on an upper end of the fixing part 29, a neck part 26 formed between the engaging part 28 and the stopper 24.

The drinking tube 20 has an inner diameter of 5 to 15 mm and in particular, the product in the market is formed with a connecting hole having an inner diameter of 8 to 9 mm wherein the contents are injected or ingested through the connecting hole.

Filling liquid-state raw materials in the conventional spout pouch as above are not difficult.

However, filling only the liquid-state raw materials can allow manufacture of the product in the form of slush or shake, but does not allow manufacture of ice cream.

The viscosity of ice cream is very high so that it is difficult to supply the ice cream through the narrow connecting hole of the drinking tube 20. Therefore, the spout pouch is not used as storage means for the ice cream.

Likewise, even in the case of frozen yogurt that has been widely sold, it is manufactured using the same method as ice cream. Therefore, its viscosity as in ice cream is high so that it is difficult to supply the yogurt through the narrow connecting hole of the drinking tube 20. As a result, the spout pouch is not used as storage means for frozen yogurt.

### SUMMARY OF THE INVENTION

The present invention proposes to solve the problems. It is an object of the present invention to provide a spout pouch ice cream and frozen yogurt manufacturing method and a device capable of injecting the ice cream or frozen yogurt, after overrunning, through a narrow drinking tube of the spout pouch.

In accordance, the current invention is providing a spout pouch ice cream and frozen yogurt manufacturing device comprising: a raw material supplying unit, supplying raw materials of ice cream or frozen yogurt; a freezer supplied with raw materials through a pump from the raw material supplying unit and manufacturing the ice cream or the frozen yogurt by injecting air while cooling the raw materials with coolant supplied from a refrigerator; a plurality of fillers receiving the ice cream or the frozen yogurt from the freezer and then filling the ice cream or the frozen yogurt to the spout pouch; a switching unit installed between the filler and the freezer to switch the supply or block of the ice cream or the frozen yogurt to each of the plurality of fillers; a control valve connected to a nitrogen tank to control the supply of nitrogen gas that cools a connecting pipe between the filler and the freezer; and a controller controlling the pump, the switching unit, the refrigerator, and the control valve.

Preferably, the raw material supplying unit consists of a raw material tank supplied with raw materials from the external and storing them; an agitator agitating the raw materials stored in the raw material tank; and a mixing tank temporally storing the raw materials supplied from the raw material tank.

The refrigerator is a two-stage refrigerator.

In accordance, the present invention provides a spout pouch ice cream and frozen yogurt manufacturing method using a spout pouch ice cream and frozen yogurt manufacturing device as described above, comprising the steps of: pre-cooling a connecting pipe between a plurality of fillers and a freezer to be at the same temperature as the production temperature of the ice cream or the frozen yogurt; overrunning that cools the raw materials supplied from the raw material supplying unit to the freezer and injects air by means of a pump; and filling the ice cream or the frozen yogurt, completed by overrunning, in a spout pouch mounted to the plurality of fillers.

The method further comprises the step of removing the spout pouch buffered with the ice cream or the frozen yogurt via the filling step and replacing it with a new spout pouch.

The overrunning constantly maintains the temperature of the ice cream or the frozen yogurt manufactured by means of the pressure control of an amp for a blade and the pump mounted inside the freezer.

The raw materials of the ice cream or the frozen yogurt supplied to the freezer are 36 to 38° F.

The injection amount of air of the ice cream or the frozen yogurt is 20% to 35% based on the volume of the ice cream or the frozen yogurt.

The temperature of the ice cream or the frozen yogurt discharged from the freezer is −16 to 0° F.

The pressure of the pump is 20 to 35 psi.

According to the present invention, the ice cream or the frozen yogurt can be injected into the inner diameter (8 to 9 mm) of the drinking tube of the spout pouch.

Accordingly, it is possible to manufacture the spout pouch type of ice cream or frozen yogurt that can have the advantages of the spout pouch and enjoy the inherent taste of ice cream or frozen yogurt.

### BRIEF DESCRIPTION OF THE DRAWING

These and other objects, features, and advantages of preferred embodiments of the present invention will be more fully described in the following detailed description, taken in conjunction with the accompanying drawings. In the drawings:

FIG. 1 is a schematic view of a spout pouch according to the prior art.

FIG. 2 is a front view of a drinking tube of FIG. 1.

FIG. 3 is a block diagram of a spout pouch ice cream and frozen yogurt manufacturing device according to a preferred embodiment of the present invention.

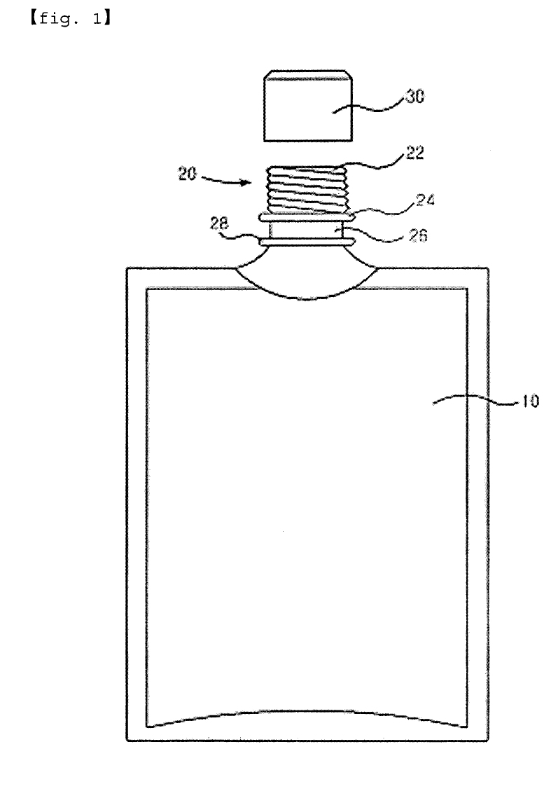

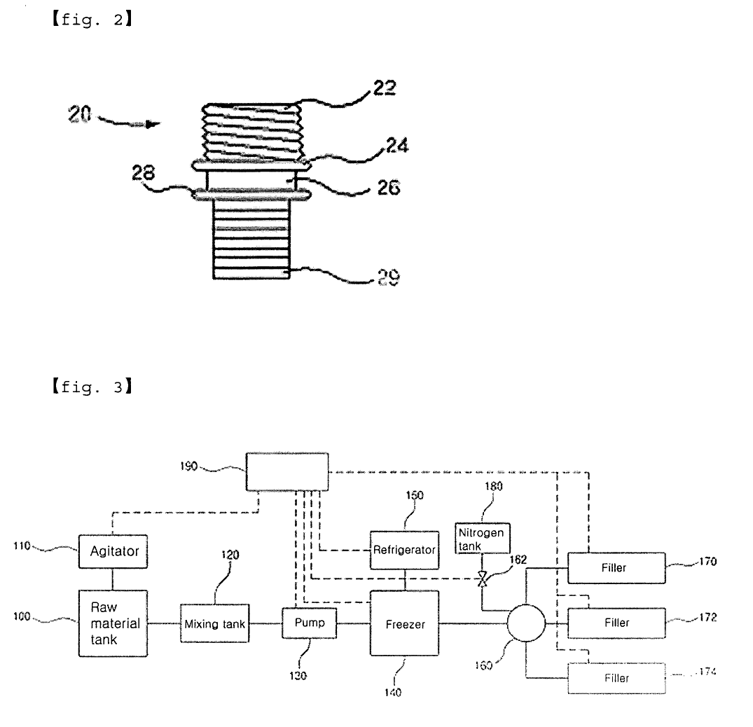

### DETAILED DESCRIPTION OF THE INVENTION

Hereinafter, preferred embodiments of the present invention will be described with reference to the accompanying drawings for instance denoting reference numerals to components of each drawing, such as denoting numerals to alike components throughout the overall drawings. The detailed description of known functions and configurations will be omitted so as not to obscure the subject of the present invention with unnecessary detail.

FIG. 3 is a block diagram of a spout pouch ice cream and frozen yogurt manufacturing device according to an embodiment of the present invention.

The spout pouch ice cream or frozen yogurt manufacturing device primarily comprises a raw material supplying unit that supplies raw materials; a freezer 140 manufacturing the ice cream or frozen yogurt with the raw materials supplied from the raw material supplying unit; and fillers 170, 172 and 174 filling the ice cream or the frozen yogurt supplied from the freezer 140 in the spout pouch.

The raw material supplying unit comprises a raw material tank 100 supplied with the raw materials from the external and storing them, an agitator 110 agitating the raw materials stored in the raw material tank 100, a mixing tank 120 temporally storing the raw materials supplied from the raw material tank 100, and a pump 130 applying pressure to the ice cream raw materials in the mixing tank 120 to supply them to the freezer 140.

The agitator 110 may comprise a motor in a known art, an agitating axis connected to the motor and agitating blades formed on outer circumference of the agitating axis, all of which are not shown in the drawing.

The agitator 110 continuously operates to serve a role of preventing several materials from being separated from each other and precipitated.

The raw material tank 100 has a receiving space larger than that of the mixing tank 120 and is supplied with milk, spices, or the like, which are raw materials of ice cream or frozen yogurt, from the external device (not shown).

The mixing tank 120 is manufactured to be smaller in size than the raw material tank 100 in order to meet the production capacity of the pump 130 and the freezer 140 and can inject a fixed quantity of additives such as food colors to the mixing tank 120 through an additive supplying source (not shown).

The freezer 140 is a device which cools the raw materials of the ice cream or the frozen yogurt and at the same time, performs the overrun process and is connected to a refrigerator 150.

More specifically, the ice cream or the frozen yogurt is manufactured inside of the freezer 140 by freezing the raw materials through the evaporation of frozen liquid in a freezer accumulator tank installed inside the freezer 140. At this time, the quality of product can be made uniform by controlling coolant per unit mass applied to the ice cream or the frozen yogurt by means of the control of pressure in the pump.

Also, the inside of the freezer 140 is installed with a blade (not shown). The ice cream or the frozen yogurt raw materials are agitated inside the freezer by means of the continuous rotation of the blade.

At this time, the viscosity of the ice cream or the frozen yogurt can be maintained at a constant level by means of the amount of agitation (referred to as an amp of the blade. That is, the viscosity of the ice cream or the frozen yogurt can be lowered by supplying energy to the ice cream or the frozen yogurt by agitation. In other words, the viscosity can be high by making the size of the amp large, while when the viscosity is to be lower than a certain level, the size of the amp is made small.

Therefore, the production of the ice cream or the frozen yogurt can be controlled by means of the pressure of the amp and pump 130.

Preferably, the refrigerator 150 adopts a two-stage refrigerator to continuously supply the coolant.

The freezer 140 is connected to the plurality of fillers 170, 172, and 174. At this time, the switching unit 160 is installed between the freezer 140 and the plurality (for example, three) of fillers 170, 172, and 174, making it possible to selectively switch the connection of the fillers 170, 172, and 174 and the freezer 140. Thus, the ice cream or the frozen yogurt from the freezer 140 is selectively supplied to each of the plurality of fillers 170, 172, and 174 by the switching action of the switching unit 160.

The fillers 170, 172, and 174 can be mounted with the spout pouch (not shown). After the filling of the ice cream supplied from the freezer 140 is completed, it is preferable to manufacture the filler to automatically remove the mounted spout pouch and mount a new spout pouch.

Also, in order to cool a connecting pipe mounted between the freezer 140 and the fillers 170, 172, and 174, the manufacturing device of the present invention is provided with nitrogen tank 180 containing nitrogen, and a control valve 162 to control the amount of nitrogen supplied from a nitrogen tank 180.

And, the manufacturing device of the present invention further includes a controller 190 to control the operation of the pump 130, the switching unit 160, the refrigerator 150, and the control valve 162.

The spout pouch ice cream or the frozen yogurt manufacturing device according to the embodiment of the present invention is basically configured as above. Hereinafter, the spout pouch ice cream or the frozen yogurt manufacturing method using the spout pouch ice cream or the frozen yogurt manufacturing device will be described.

Each of the fillers 170, 172, and 174 is mounted with the spout pouch and the raw material tank 100 is filled with the raw materials of the ice cream or the frozen yogurt.

First, the connecting pipe between the fillers 170, 172, and 174 and the freezer 140 is pre-cooled to a temperature necessary for manufacturing the ice cream or the frozen yogurt.

At this time, the pre-cooling is performed by nitrogen gas discharging from the nitrogen tank 180 and the control valve 162 controls the supply amount of the nitrogen gas in order to control the temperature.

Such a pre-cooling process is the most important process in the spout pouch ice cream or the frozen yogurt manufacturing method of the invention. The pre-cooling process should be performed at the same temperature as the product at a production starting time or otherwise, the overrun process can not be performed by the set amount due to the temperature difference with the raw materials so that the content of ice cream finally manufactured is small and ice particles occur within the spout pouch due to the temperature difference.

Therefore, when cutting and viewing the spout pouch product manufactured without performing the pre-cooling process, it can be appreciated that the raw material separating phenomenon occurs and a phenomenon of significantly degrading the quality of product (texture as the ice cream or the frozen yogurt, not the shake or the smoothie) occurs.

When the pre-cooling process is completed, the manufacturing of the ice cream or the frozen yogurt and the filling in the spout pouch starts.

The temperature of the raw materials supplied to the freezer 140 is 36 to 38° F. and the injection amount of air upon performing the overrun process is 20 to 35% based on the volume of the raw materials of the ice cream or the frozen yogurt.

And, the product temperature at the outlet discharging the ice cream or the frozen yogurt manufactured by the freezer 140 is set to −16 to 0° F.

At this time, the pressure and temperature are controlled by the pump 130 and the refrigerator 150 to constantly maintain the temperature of the ice cream or the frozen yogurt manufactured by the freezer 140.

In particular, it is preferable that the refrigerator 150 is the two-stage refrigerator in order to continuously supply the coolant.

Also, when continuous supplying of the ice cream or the frozen yogurt through the connecting pipe, the connecting pipe is excessively cooled over time so that overload occurs in the refrigerator 150 and the pump 130.

Therefore, it is preferable to prevent the excessive cooling of the connecting pipe by raising the discharging temperature of the ice cream or the frozen yogurt to the connecting pipe at regular time intervals.

The control of the discharging temperature of the ice cream or the frozen yogurt is performed by means of the increase of the supply amount of raw materials and the increase of the amp for the blade according to the pressure control of the pump 130.

The pressure control of the pump 130 is performed in the range of 20 to 35 psi.

Therefore, the product temperature of the ice cream or the frozen yogurt always reaching the spout pouch can be constantly maintained by raising the temperature of the ice cream or the frozen yogurt discharged from the freezer 130 and passing through a pipeline. The product temperature of the ice cream or the frozen yogurt reaching the spout pouch should be constantly maintained so that the amount of the overrun can be constantly maintained.

The continuously produced ice cream or frozen yogurt is filled in the spout pouch (not shown) mounted to the fillers 170, 172, and 174.

At this time, the plurality of fillers 170, 172, and 174 and the freezer 130 are selectively selected by means of the switching unit 160. In the buffered case, the spout pouch mounted to the plurality of fillers 170, 172, and 174 is removed and a new spout pouch is mounted thereto.

Therefore, the spout pouch type of ice cream or frozen yogurt can be continuously manufactured.

Those skilled in the art will appreciate that the specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. A spout pouch ice cream and frozen yogurt manufacturing device comprising:
a. the raw material supplying unit supplying raw materials of ice cream or frozen yogurt;
b. the freezer supplied with raw materials through a pump from the raw material supplying unit;
c. manufacturing of the ice cream or the frozen yogurt by injecting air while cooling the raw materials with coolant supplied from a refrigerator;
d. plurality of fillers receiving the ice cream or the frozen yogurt from the freezer and then filling the ice cream or the frozen yogurt to the spout pouch;
e. a switching unit installed between the filler and the freezer to switch the supply or block of the ice cream or the frozen yogurt to each of the plurality of fillers;
f. a control valve connected to a nitrogen gas tank to control the supply of nitrogen gas that cools a connecting pipe between the filler and the freezer;
g. a controller controlling the pump, the switching unit, the refrigerator, and the control valve.

2. The device as claimed in claim 1, wherein the raw material supplying unit comprises:
a. the raw material tank supplied with raw materials from the external and storing them;
b. an agitator agitating the raw materials stored in the raw material tank;
c. mixing tank temporally storing the raw materials supplied from the raw material tank.

3. The device as claimed in claim 1, wherein the refrigerator is a two-stage refrigerator.

4. A spout pouch ice cream and frozen yogurt manufacturing method using a spout pouch ice cream and frozen yogurt manufacturing device as claimed in claim 1, comprising the steps of:
pre-cooling a connecting pipe between a plurality of fillers and a freezer to be at the same temperature as the production temperature of the ice cream or the frozen yogurt;
overrunning that cools the raw materials supplied from the raw material supplying unit to the freezer and injects air by a pump; and
filling the ice cream or the frozen yogurt, completed by overrunning, in a spout pouch mounted to the plurality of fillers.

5. The method as claimed in claim 4, further comprising the step of removing the spout pouch buffered with the ice cream or the frozen yogurt via the filling step and replacing it with a new spout pouch.

6. The method as claimed in claim 4, wherein the overrunning constantly maintains the temperature of the ice cream or the frozen yogurt manufactured by the pressure control of an amp for a blade and the pump mounted inside the freezer.

7. The method as claimed in claim 4, wherein the raw materials of the ice cream or the frozen yogurt supplied to the freezer are 36 to 38° F.

8. The method as claimed in claim 4, wherein the injection amount of air of the ice cream or the frozen yogurt is 20 to 35% based on the volume of the ice cream or the frozen yogurt.

9. The method as claimed in claim 4, wherein the temperature of the ice cream or the frozen yogurt discharged from the freezer is −16 to 0° F.

10. The method as claimed in claim 4, wherein the pressure of the pump is 20 to 35 psi.
